(19) United States
(12) Patent Application Publication
(10) Pub. No.: US 2021/0334375 A1
(43) Pub. Date: Oct. 28, 2021

(54) Malicious Event Detection in Computing Environments

(71) Applicant: Citrix Systems, Inc., Fort Lauderdale, FL (US)

(72) Inventors: Dan Hu, Nanjing (CN); Yuan Zhang, Nanjing (CN); Xiaolu Chu, Nanjing/Jiangsu (CN)

(21) Appl. No.: 15/930,770

(22) Filed: May 13, 2020

Related U.S. Application Data
(63) Continuation of application No. PCT/CN20/86699, filed on Apr. 24, 2020.

(51) Int. Cl. G06F 21/56; G06F 21/55

(52) U.S. Cl. CPC G06F 21/567; G06F 2221/033; G06F 21/554

(57) ABSTRACT

Methods and systems for detecting malicious events in computing systems are described herein. Relationships between events occurring at computing systems are identified. The identified relationships are compared to a series of events previously determined to be a malicious activity to determine whether the identified relationship is potentially malicious activity. If the identified relationship is determined to be potentially malicious, actions can be taken to mitigate damages caused by the events in the identified relationship.

### CROSS-REFERENCE TO RELATED APPLICATIONS

The present application is a continuation of International Application No. PCT/CN20/86699, filed Apr. 24, 2020, and entitled “Malicious Event Detection In Computing Environments,” which is hereby incorporated by reference as to its entirety.

### FIELD

Aspects described herein generally relate to computer networking, remote computer access, virtualization, enterprise mobility management, and hardware and software related thereto. More specifically, one or more aspects described herein relate to the detection of malicious activities in various computing systems.

### BACKGROUND

Modern computerized systems are often threatened by malicious attacks. Some attacks may be targeted at a specific computing device or network, such as causing targeted damage or collecting specific information. Other attacks may be more general and are targeted at a wide range of computing devices and networks. The attacks may be carried out using “malware” or malicious software (e.g., viruses, worms, Trojan horses, ransomware, rootkits, spyware, adware, or rogue security software).

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards methods and systems for dynamically detecting malicious events in various computing systems. A computing device may receive data indicative of occurrences of a series of events in a client device. The computing device may identify a relationship between two or more events executed by a first application from the series of events. The computing device may compare the identified relationship between the events with other series of events previously determined to be malicious activity. If the computing device finds a match between the identified relationship and a series of events previously determined to be a malicious activity, the computing device may identify one or more events in the identified relationship as potentially malicious activity. The computing device may initiate actions to modify the configuration of the client device responsive to the determination that the events in the identified relationship are potentially malicious.

In some examples, the computing data may select the series of events based on a determination that each event from the series of events satisfies one or more event selection rules. In some examples, the computing device may receive the data from a client agent that enables a virtual environment on the client device.

In some examples, the computing device may identify the relationship between two or more events executed by a first application by determining one or more second applications that enabled the execution of the first application, one or more third applications executed by the first application, and events indicating relationships among the first application, the one or more second applications, and the one or more third applications.

In some examples, in response to the identified relationship being potentially malicious activity, the computing device may initiate an action to modify the configuration of the client device. For example, the computing device may cause an ending of the execution of any application that executed any one of the events in the identified relationship. The computing device may initiate repair of damages caused by one or more events in the identified relationship. The computing device may also cause the output of a notification indicating that one or more events in the identified relationship are malicious. In some examples, an event from the identified relationship may satisfy one or more triggering rules from a list of triggering rules. The computing device may determine an event associated with a download of the first application on the client device and add the event associated with the download to the list of triggering rules.

In some examples, a computing device may determine that the identified relationship does not match a portion of any previously determined malicious series of events or any previously determined benign series of events. The computing device may cause an output indicating the presence of the identified relationship. The computing device may receive an indication that the identified relationship is determined as a malicious activity.

In some examples, a client agent, enabling a virtual environment on a client device, may identify a relationship between two or more events of the first application based on a series of events that occurred in the virtual environment. The client agent may send data associated with the identified relationship to a server that enables the detection of potentially malicious activity. The client agent may receive an indication from the server that an event from the identified relationship is potentially malicious activity based on a comparison between the identified relationship and other series of events previously determined to be malicious activity. The client agent may initiate an action to modify a configuration of the virtual environment responsive to the determination that the event is potentially malicious activity.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative cloud-based system architecture that may be used in accordance with one or more illustrative aspects described herein.

FIG. 4 depicts another illustrative cloud-based system architecture that may be used in accordance with one or more illustrative aspects described herein.

FIG. 5 depicts a schematic diagram showing an example system detecting malicious events in client devices.

FIG. 6 depicts a schematic diagram showing another example system detecting malicious events in client devices.

FIG. 7 is a flowchart showing an example method for generating an event tree.

FIGS. 8A, 8B, 8C, 8D, and 8E collectively depict an example event record and an example event sequence showing the generation of an event tree.

FIG. 9 is a flowchart showing an example method for detecting a malicious event tree structure.

FIG. 10 is a flowchart showing an example method for classifying an event tree structure as malicious or benign.

### DETAILED DESCRIPTION

In the following description of the various embodiments, reference is made to the accompanying drawings identified above and which form a part hereof, and in which is shown by way of illustration, various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

One problem associated with malicious behavior detection in computing systems may relate to the tradeoff between the effort to identify malicious behavior (or attacks) and the level of security needed to operate computing systems. On the one hand, a high level of security often comes at a high cost that may be prohibitive. In particular, analyzing computing device events at such a large scale may also require a large number of resources, such as computing time, power, storage, and so on. Additionally, current robust security techniques generate many false positive alerts identifying legitimate activities as malicious, which is inefficient, costly, and time consuming to evaluate. On the other hand, analyzing a smaller amount of information, such as single suspicious events, may prove ineffective by missing many malicious attacks. In addition, smaller sized groups of events may not include other events related to a malicious attack, and thus make results from any analysis of those groups of events ineffective concerning identification and/or prevention of such attacks.

As a general introduction to the subject matter described in more detail below, aspects described herein are directed towards identifying malicious events in computing systems. After finding a triggering event that may potentially be malicious, one or more source events that contribute to the initiation of the triggering event and all related events following the triggering event may be identified. An event tree structure may be generated with the triggering event, the source events, and the events following the triggering events. Events in the generated event tree structure may be in chronological order. In some examples, nodes in the generated event tree structure may be the events. In other embodiments, the generated event tree structure may comprise nodes that depict various applications that initiated the events, and the connections between the nodes may depict the events. The arrangement of the nodes in the generated event tree structure may depict the sequential execution of various applications from which a determination can be made as to whether or not an event is a malicious attack or behavior. The generated event tree structure may identify all or some impacted components of the triggering event.

A malicious event detector may compare the generated event tree structure to a plurality of event tree structures that have been previously recognized as malicious. If the generated event tree structure at least partially matches a previously recognized malicious event tree structure, the triggering event is said to be a malicious event. In this way, the malicious event detector may ensure that at least a partial history of the triggering event is considered and not just the single triggering event to determine whether the triggering event is malicious. As a result, there will be fewer false positive and false negative identifications of malicious attacks. More proper identification of malicious events may enable remedial actions (e.g., automatic actions) to be taken that minimize the negative impacts of the malicious triggering event.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected” and “coupled,” and similar terms are meant to include both direct and indirect connecting and coupling.

Computing Architecture

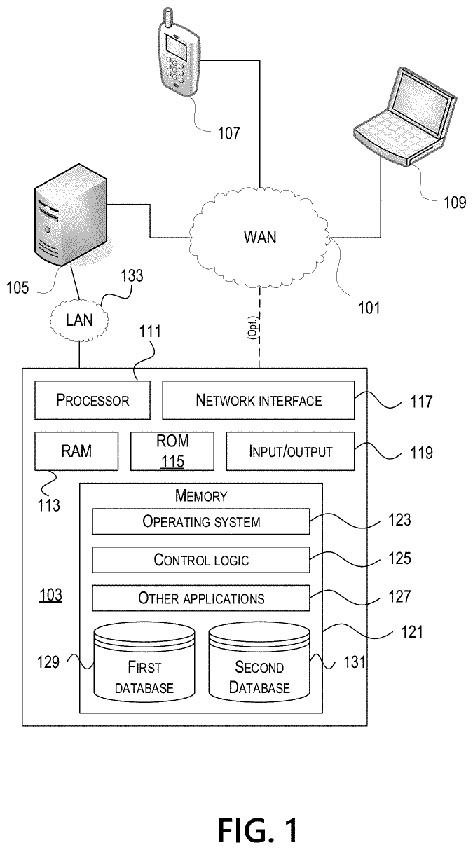

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control, and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling the overall operation of the data server 103. Data server 103 may further include random access memory (RAM) 113, read-only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling the overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. The functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in the performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

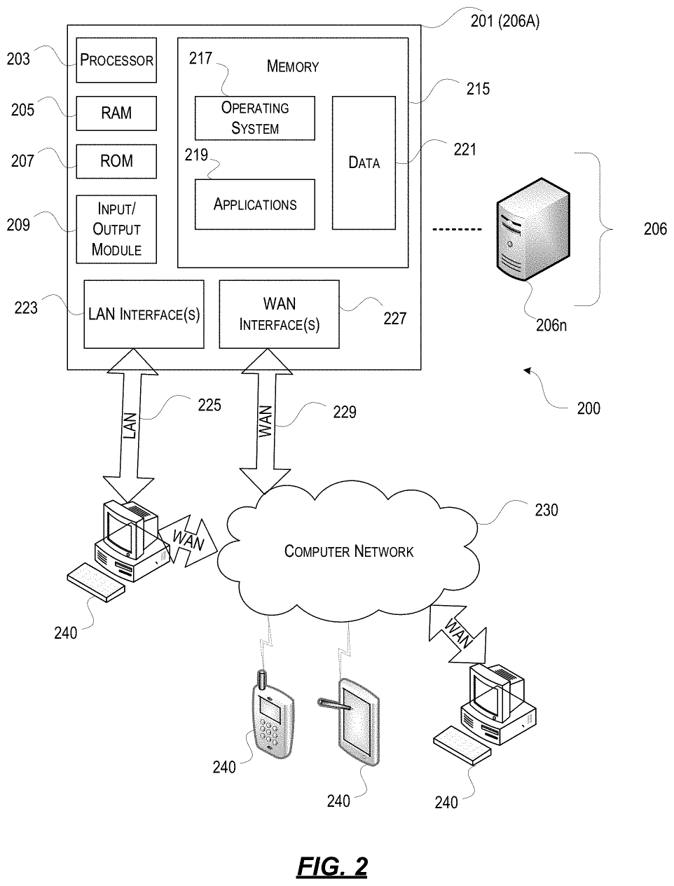

With further reference to FIG. 2, one or more aspects described herein may be implemented in a remote-access environment. FIG. 2 depicts an example system architecture, including a computing device 201 in an illustrative computing environment 200 that may be used according to one or more illustrative aspects described herein. Computing device 201 may be used as a server 206A in a single-server or multi-server desktop virtualization system (e.g., a remote access or cloud system) and can be configured to provide virtual machines for client access devices. The computing device 201 may have a processor 203 for controlling the overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set-top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases, can load balance client connections amongst a plurality of backend servers 206.

The client machine(s) 240 may, in some embodiments, be referred to as a single client machine 240 or a single group of client machines 240, while server(s) 206 may be referred to as a single server 206 or a single group of servers 206. In one embodiment, a single client machine 240 communicates with more than one server 206, while in another embodiment, a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments, the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects, the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples, the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments, the server farm 206 may be administered as a single entity, while in other embodiments, the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

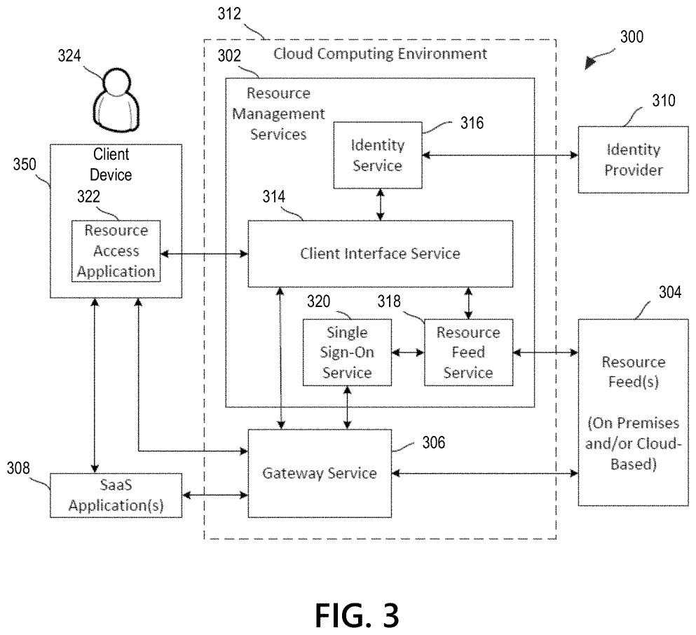

FIG. 3 illustrates an example multi-resource access system 300 in which one or more resource management services 302 may manage and streamline access to one or more client devices 350 for one or more resource feeds 304 (via one or more gateway services 306) and/or one or more software-as-a-service (SaaS) applications 308. In some examples, the resource management service(s) 302 may employ an identity provider 310 to authenticate the identity of a user of a client device 350 and, following authentication, identify one of more resources the user is authorized to access. In response to the user selecting one of the identified resources, the resource management service(s) 302 may send appropriate access credentials to the requesting client device 350, and the client device 350 may then use those credentials to access the selected resource. For the resource feed(s) 304, the client device 350 may use the supplied credentials to access the selected resource via a gateway service 306. For the SaaS application(s) 308, the client device 350 may use the credentials to access the selected application directly.

The client devices(s) 350 may be any type of computing devices capable of accessing the resource feed(s) 304 and/or the SaaS application(s) 308, and may, for example, include a variety of desktop or laptop computers, smartphones, tablets, etc. The resource feed(s) 304 may include any of numerous resource types and may be provided from any of numerous locations. In some embodiments, for example, the resource feed(s) 304 may include one or more systems or services for providing virtual applications and/or desktops to the client devices 350, one or more file repositories and/or file sharing systems, one or more secure browser services, one or more access control services for the SaaS applications 308, one or more management services for local applications on the client devices 350, one or more internet enabled devices or sensors, one or more systems detecting malicious activities in the client devices 350, etc. The resource management service(s) 302, the resource feed(s) 304, the gateway service(s) 306, the SaaS application(s) 308, and the identity provider 310 may be located within an on-premises data center of an organization for which the multi-resource access system 300 is deployed, within one or more cloud computing environments, or elsewhere.

The various resource management services 302, as well as a gateway service 306, may be located within a cloud computing environment 312. The cloud computing environment may, for example, include Microsoft Azure Cloud, Amazon Web Services, Google Cloud, or IBM Cloud. It should be appreciated, however, that in other implementations, one or more (or all) of the components of the resource management services 302 and/or the gateway service 306 may alternatively be located outside the cloud computing environment 312, such as within a data center hosted by an organization.

For any of the illustrated components (other than the client device 350) that are not based within the cloud computing environment 312, cloud connectors (not shown in FIG. 3) may be used to interface those components with the cloud computing environment 312. Such cloud connectors may, for example, run on Windows Server instances and/or Linux Servers instances hosted in resource locations and may create a reverse proxy to route traffic between those resource locations and the cloud computing environment 312. In the illustrated example, the cloud-based resource management services 302 include a client interface service 314, an identity service 316, a resource feed service 318, and a single sign-on service 320. As shown, in some embodiments, the client device 350 may use a resource access application 322 to communicate with the client interface service 314 as well as to present a user interface on the client device 350 that a user 324 can operate to access the resource feed(s) 304 and/or the SaaS application(s) 308. The resource access application 322 may either be installed on the client device 350 or may be executed by the client interface service 314 (or elsewhere in the multi-resource access system 300) and accessed using a web browser (not shown in FIG. 3) on the client device 350.

As explained in more detail below, in some embodiments, the resource access application 322 and associated components may provide the user 324 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, detection and notifications of malicious activities, and other data. When the resource access application 322 is launched or otherwise accessed by the user 324, the client interface service 314 may send a sign-on request to the identity service 316. The resource feed service 318 may request identity tokens for configured resources from the single sign-on service 320. The resource feed service 318 may then pass the feed-specific identity tokens it receives to the points of authentication for the respective resource feeds 304. The resource feeds 304 may then respond with lists of resources configured for the respective identities. The resource feed service 318 may then aggregate all items from the different feeds and forward them to the client interface service 314, which may cause the resource access application 322 to present a list of available resources on a user interface of the client device 350. The list of available resources may, for example, be presented on the user interface of the client device 350 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file-sharing systems (e.g., Sharefile®, one or more secure browsers, one or more internet enabled devices or sensors, one or more local applications installed on the client device 350, and/or one or more SaaS applications 308 to which the user 324 has subscribed. The lists of local applications and the SaaS applications 308 may, for example, be supplied by resource feeds 304 for respective services that manage which such applications are to be made available to the user 324 via the resource access application 322. Examples of SaaS applications 308 that may be managed and accessed as described herein include Microsoft Office 365 applications, SAP SaaS applications, Workday applications, etc. The resource access application 322 may monitor events occurring in the virtual environment at the resident client device 350. The resource access application 322 may produce an event record that includes data describing the one or more events. The resource access application 322 may periodically or continuously send event records to resource management services 302. In some examples, the resource access application 322 may identify one or more relationships between the events and sent data associated with the relationships to the resource access application 322.

For resources other than local applications and the SaaS application(s) 308, upon the user 324 selecting one of the listed available resources, the resource access application 322 may cause the client interface service 314 to forward a request for the specified resource to the resource feed service 318. In response to receiving such a request, the resource feed service 318 may request an identity token for the corresponding feed from the single sign-on service 320. The resource feed service 318 may then pass the identity token received from the single sign-on service 320 to the client interface service 314 where a launch ticket for the resource may be generated and sent to the resource access application 322. Upon receiving the launch ticket, the resource access application 322 may initiate a secure session to the gateway service 306 and present the launch ticket. When the gateway service 306 is presented with the launch ticket, it may initiate a secure session to the appropriate resource feed and present the identity token to that feed to seamlessly authenticate the user 324. Once the session initializes, the client device 350 may proceed to access the selected resource.

When the user 324 selects a local application, the resource access application 322 may cause the selected local application to launch on the client device 350. When the user 324 selects a SaaS application 308, the resource access application 322 may cause the client interface service 314 to request a one-time uniform resource locator (URL) from the gateway service 306 as well a preferred browser for use in accessing the SaaS application 308. After the gateway service 306 returns the one-time URL and identifies the preferred browser, the client interface service 314 may pass that information along to the resource access application 322. The client device 350 may then launch the identified browser and initiate a connection to the gateway service 306. The gateway service 306 may then request an assertion from the single sign-on service 320. Upon receiving the assertion, the gateway service 306 may cause the identified browser on the client device 350 to be redirected to the login page for identified SaaS application 308 and present the assertion. The SaaS may then contact the gateway service 306 to validate the assertion and authenticate the user 324. Once the user has been authenticated, communication may occur directly between the identified browser and the selected SaaS application 308, thus allowing the user 324 to use the client device 350 to access the selected SaaS application 308.

In some embodiments, in addition to or in lieu of providing the user 324 with a list of resources that are available to be accessed individually, as described above, the user 324 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to client devices 350 to notify a user 324 of something that requires the user's attention (e.g., approval of an expense report, new course available for registration, etc.).

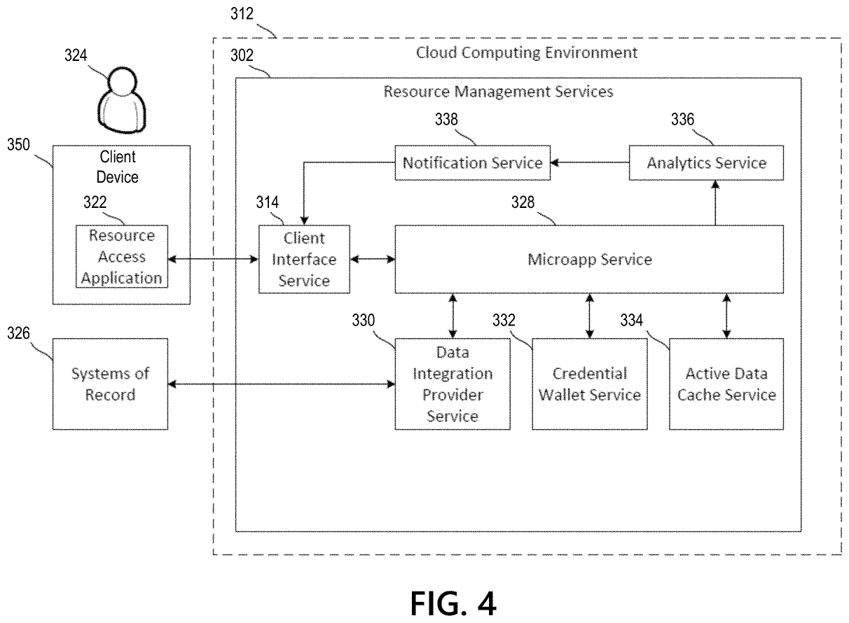

FIG. 4 is a block diagram similar to that shown in FIG. 3 but in which the available resources (e.g., SaaS applications, web applications, Windows applications, Linux applications, desktops, file repositories, malicious activity detection system, and/or file sharing systems, and other data) are represented by a single box 326 labeled “systems of record,” and further in which several different services are included within the resource management services block 302. As explained below, the services shown in FIG. 4 may enable the provision of a streamlined resource activity feed and/or notification process for a client device 350. In the example shown, in addition to the client interface service 314 discussed above, the illustrated services include a microapp service 328, a data integration provider service 330, a credential wallet service 332, an active data cache service 334, an analytics service 336, and a notification service 338. In various embodiments, the services shown in FIG. 4 may be employed either in addition to or instead of the different services shown in FIG. 4. Further, it should be appreciated that, in other implementations, one or more (or all) of the components of the resource management services 302 shown in FIG. 4 may alternatively be located outside the cloud computing environment 312, such as within a data center hosted by an organization.

In some embodiments, a microapp may be a single-use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 322 without having to launch the native application. The system, for example, aggregate relevant notifications, tasks, and insights, and thereby give the user 324 a dynamic productivity tool. In some embodiments, the resource activity feed may be intelligently populated by utilizing machine learning and artificial intelligence (AI) algorithms. Further, in some implementations, microapps may be configured within the cloud computing environment 312, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4, the systems of record 326 may represent the applications and/or other resources the resource management services 302 may interact with to create microapps. These resources may be SaaS applications, legacy applications, or homegrown applications, and can be hosted on-premises or within a cloud computing environment. Connectors with out-of-the-box templates for several applications may be provided, and integration with other applications may additionally or alternatively be configured through a microapp page builder. Such a microapp page builder may, for example, connect to legacy, on-premises, and SaaS systems by creating streamlined user workflows via microapp actions. The resource management services 302, and in particular the data integration provider service 330, may, for example, support REST API, JSON, OData-JSON, and 6ML. As explained in more detail below, the data integration provider service 330 may also write back to the systems of record, for example, using OAuth2 or a service account.

In some embodiments, the microapp service 328 may be a single-tenant service responsible for creating the microapps. The microapp service 328 may send raw events, pulled from the systems of record 326, to the analytics service 336 for processing. The microapp service may, for example, periodically cause active data to be pulled from the systems of record 326. In some embodiments, the active data cache service 334 may be single-tenant and may store all configuration information and microapp data. It may, for example, utilize a per-tenant database encryption key and per-tenant database credentials. In some embodiments, the credential wallet service 332 may store encrypted service credentials for the systems of record 326 and user OAuth2 tokens.

In some embodiments, the data integration provider service 330 may interact with the systems of record 326 to decrypt end-user credentials and write back actions to the systems of record 326 under the identity of the end-user. The write-back actions may, for example, utilize a user's actual account to ensure all actions performed are compliant with data policies of the application or other resources being interacted with.

In some embodiments, the analytics service 336 may process the raw events received from the microapp service 328 to create targeted scored notifications and send such notifications to the notification service 338. In some examples, the analytics service 336 may host a malicious event detection system that receives from the resource access application 322 events occurring on the cloud based environment related to the client device 350 and identify relationships between one or more events from the raw events. The malicious event detection system may compare the identified relationship between the events to previously recognized malicious series of events or previously recognized benign series of events to determine whether the events in the identified relationship constitute malicious activities.

Finally, in some embodiments, the notification service 338 may process any notifications it receives from the analytics service 336. In some implementations, the notification service 338 may store the notifications in a database to be later served in an activity feed. In other embodiments, the notification service 338 may additionally or alternatively send the notifications out immediately to the client device 350 as a push notification to the user 324.

In some embodiments, a process for synchronizing with the systems of record 326 and generating notifications may operate as follows. The microapp service 328 may retrieve encrypted service account credentials for the systems of record 326 from the credential wallet service 332 and request a sync with the data integration provider service 330. The data integration provider service 330 may then decrypt the service account credentials and use those credentials to retrieve data from the systems of record 326. The data integration provider service 330 may then stream the retrieved data to the microapp service 328. The microapp service 328 may store the received systems of record data in the active data cache service 334 and also send raw events to the analytics service 336. The analytics service 336 may create targeted scored notifications and send such notifications to the notification service 338. The notification service 338 may store the notifications in a database to be later served in an activity feed and/or may send the notifications out immediately to the client device 350 as a push notification to the user 324.

Detecting Malicious Events

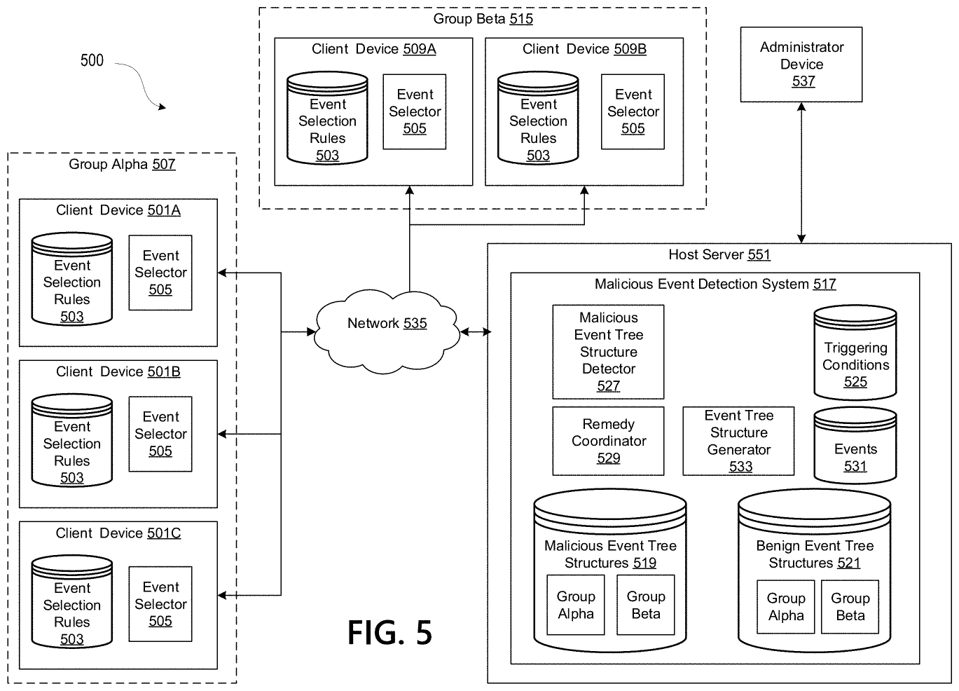

FIG. 5 depicts a schematic diagram showing an example system 500 detecting malicious events in client devices. The system may comprise one or more client devices (e.g., the client devices 501A-501C, the client devices 509A-509B), one or more networks (e.g., the network 535), one or more administrator devices (e.g., the administrator device 537), and one or more host server hosting a malicious event detection system (e.g., the host server 551 hosting a malicious event detection system 517). In some examples, one or more of the devices in the system (and/or the functionalities thereof) may be implemented in a single computing device, as desired by a person of ordinary skill in the art.

The network 535 may comprise one or more of any of various types of information distribution networks, such as, without limitation, a satellite network, a telephone network, a cellular network, a Wi-Fi network, an Ethernet network, an optical fiber network, a coaxial cable network, a hybrid fiber-coax network, and/or so on. The network 535 may comprise an Internet Protocol (IP) based network (e.g., the Internet) or other types of networks. The network 535 may comprise, for example, the wide area network 101, the local area network 133, or the computer network 230. The network 535 may comprise one or more communication links configured to connect one or more computing devices, such as the client devices 501A-501C, 509A-509B, the administrator device 537, and/or the host server 551 comprising the malicious event detection system 517.

A client device of the client devices 501A-501C, 509A-509B may comprise, for example, a smartphone, a personal computer, a tablet, a desktop computer, a laptop computer, a gaming device, a virtual reality headset, or any other computing device. Additionally or alternatively, a client device of the client devices 501A-501C, 509A-509B may comprise, for example, the computers 107, 109, the terminals 240, or the client device 350 as discussed above in connection with FIGS. 1-4. Additionally or alternatively, a client device of the client devices 501A-501C, 509A-509B may comprise a client agent (e.g., the resource access application 322 in the client device 350 in FIGS. 3 and 4) which may be a software application executing on the client device that facilitates communications with remote resources and/or virtualized resources. The client agent, in one illustrative embodiment, may be Citrix Workspace Application by Citrix Systems, Inc. of Fort Lauderdale, Fla.

The client devices 501A-501C, 509A-509B may be logically grouped into one or more groups (e.g., the group alpha 507 comprising the client devices 501A, 501B, 501C, and the group beta 515 comprising the client devices 509A, 509B). The client devices in a group may be geographically dispersed while logically grouped together, or located proximate to each other while logically grouped together. The client devices in a group may, in some embodiments, communicate using a WAN (wide), MAN (metropolitan), or LAN (local), where different geographic regions can be characterized as: different continents; different regions of a continent; different countries; different states; different cities; different campuses; different rooms; different companies or organizations; or any combination of the preceding geographical locations.

A client device of the client devices 501A-501C, 509A-509B may comprise software components such an event selector 505. The event selector 505 monitors events occurring at the resident client device (e.g., any one of the client devices 501A-501C, 509A-509B) or a client agent (e.g., resource access application 322) executing on the resident client device (e.g., client device 350). An event may be an action or occurrence that occurs on the resident computing device or in a virtual environment enabled by a client agent in the resident computing device. Such events can be generated or triggered by the resident computing device, by the user or in other ways. A source of events may include a user of the computing device, who may interact with the software by way of, for example, keystrokes on the keyboard, mouse clicks, and so on. Software and operating system components in the computing device may also trigger events. The event selector 505 may record events occurring at the resident computing device in event records, as further described below.

The event selector 505 may produce an event record, including data describing the one or more events occurring at the resident computing device. For example, an event record can include an event type of the event (e.g., “database accessed,” “file opened,” “network connection established,” or “DNS request made”). The event record may include information about the execution of events by the application that is currently running or otherwise executable on the resident client device. In some examples, the event record may include information about at least one application and at least one related application (e.g., still running or already terminated), e.g., a parent application that initiated the event initiating application. The event record may include one or more fields, which can have a name or other identifier and include or be associated with one or more values. The event records can be represented as ASN.1-defined data structures, GOOGLE protobufs, JSON records, XML documents or subtrees, associative arrays, or other forms of tagged or key-value storage. The event records may also include, but are not limited to, event timestamps, filenames, file timestamps, filehandles, hashes of files (e.g., SHA-256 hashes), user identification numbers or other user identifiers (e.g., WINDOWS SIDs), group identifiers, program identifiers (PIDs), program output (e.g., to stdout or stderr), program exit codes, filenames of executables' primary modules, session identifiers, program command lines, raw or decoded, command-line histories, universally unique identifiers (UUIDs), operating-system identifiers, e.g., from username(1), permissions, access-control lists (ACLs), security-event indications (e.g., “logon,” “logoff”), security credentials, logon times, subsystem identifiers (e.g., console vs. graphical), virtual host identifiers (e.g., in a hypervisor-managed system), login types (e.g., with or without secure attention sequence), timestamps, blocks of data (e.g., headers or full contents of files or of regions of memory), hashes of data (e.g., of the blocks of data, such as file contents), IP or other network addresses (e.g., of computing device 104 or peers with which it is communicating or is attempting to communicate), network port numbers (e.g., local or remote), identifiers of detection module 226 (e.g., a version number), values from the registry, dotfiles, or other configuration data (e.g., crontab entries), call-stack entries, domain names (e.g., relative or full-qualified, FQDN), hostnames being resolved (e.g., using DNS), identifiers of the corresponding monitored computing devices 104 or the organizations to which they belong, names or other identifiers of mutexes, named pipes, or other inter-thread communication or inter-program communication (IPC) mechanisms, a bus path, vendor/product ID pair, or other identifier of an accessory (e.g., an add-in card, USB device, or other connectible device) or other system component, and/or counts (e.g., of VIRUSTOTAL dirty indications).

The event selector 505 may send the event records via the network 535 to the malicious event detection system 517 in the host server 551. The event selector 505 may send an event record for an event as soon as the event occurs. The event selector 505 may generate one or more event records for events that occurred within a predetermined timeframe. For example, the event selector 505 may generate an event record for events that occurred within the last 0.5 seconds, 1 second, 5 seconds, and so on. In some examples, the event selector 505 may send the event records to the malicious event detection system 517 as soon as the events are recorded in the event records. In some examples, the event selector 505 may send the event records in batches (e.g., a batch of two event records, a batch of 5 event records, a batch of 10 event records, and so on). In some examples, the event selector 505 may send the event records to the malicious event detection system 517 individually. The event record may be in various formats including, but not limited to, Extensible Markup Language (XML), JavaScript Object Notation (JSON), Hypertext Markup Language (HTML), spreadsheet formats such as Comma-Separated Value (CSV), archive formats such as gzip, or others.

In some examples, the event selector 505 may send all occurring events in the resident client device to the malicious event detection system 517. Alternately, the event selector 505 may send a subset of events occurring at the resident client device to the malicious event detection system 517. The resident client device may also comprise an event selection rules database 503 that stores event selection rules. The event selection rules may enable the event selector 505 to filter events that are more likely to be indicative of malicious activities so that those events can be sent to the malicious event detection system 517. For example, the event selection rules in the event selection database may specify that events relating to user events, such as mouse clicks, keyboard strokes are less likely to be indicative of or otherwise be part of malicious events. Additionally, the event selection rules in the event selection database may specify that certain events, such as downloading a software application, executions of software applications, downloading emails with attachments, and/or creating transport layer security connections to a remote computing device outside the network, are more likely indicative of malicious events. The event selector 505 may analyze the events occurring in the resident client device and determine whether any of the occurring events satisfies one or more selection rules in the event selection rules database 503. The events that satisfy at least one selection rule from the event selection rules database 503 may be selected to be included in the subset of events that will be sent to the malicious event detection system 517.

The host server 551 may be configured to host various services and/or to deliver the services to the client devices 501A-501C, 509A-509B. The host server 551 may comprise, for example, a physical computing device (e.g., a server, etc.). Additionally or alternatively, the host server 551 may comprise, for example, the computers 103, 105, the servers 206, the virtualization server 301, or the management server 410, as discussed above in connection with FIGS. 1-4. The host server 551 may be configured to host various services, such as virtual desktops, virtual applications, web applications, and/or the like, and to deliver the services to the client devices 501A-501C, 509A-509B. For example, the host server 551 may comprise the malicious event detection system 517 to detect malicious events in one or more of the client devices 501A-501C, 509A-509B, and initiate remediation actions (e.g., to remedy damages caused in the client devices by the malicious events).

The malicious event detection system 517 may be implemented, for example, on one or more host servers (e.g., the host server 551). The malicious event detection system 517 can be implemented on the host server 551 as a Software-as-a-Service (SaaS) application, a web-architected application, or a cloud-delivered service. The malicious event detection system 517 can be implemented in the context of any computer-implemented system, including a database system, a multi-tenant environment, or a relational database implementation.

Some or all of the data related to the malicious event detection system 517 may be stored using one or more databases. For example, the malicious event detection system 517 may also include a triggering conditions database 525, an events database 531, a malicious event tree structures database 519, and/or a benign event tree structure database 521. Databases may include but are not limited to relational databases, hierarchical databases, distributed databases, in-memory databases, flat file databases, XML databases, NoSQL databases, graph databases, and/or a combination thereof. The malicious event detection system 517 may receive data or event records of events occurring at the client devices 501A-501C, 509A-509B, and store the data or the event records at the events database 531.

Software applications that usually display malicious behaviors may initiate events that satisfy one or more trigger conditions. Trigger conditions may be related to many different trigger types, such as time, system events, application events, and/or network events. Examples of trigger conditions include event occurring on specific dates when many viruses attack their host systems, such as Friday the 13th or April Fool's Day, downloading software applications from websites known to be infected with viruses, modification to core files of the operating systems of the client devices, keystrokes to files containing certain keywords, certain network commands, connecting to a remote computing device located outside an organization's network, downloading an email attachment of an unknown file type, and so on. The triggering conditions database 525 may comprise rules that define the underlying logic for identifying trigger conditions for malicious events. A rule may be a conditional statement (e.g., if A and B, then C) that may form of implication between an antecedent (e.g., A and B), and a consequent (e.g., C). Whenever the conditions specified in the antecedents are true, the conditions specified in the consequents must also be true. The antecedents of the rules may define the constraints for a particular trigger condition.

The malicious event tree structures database 519 may comprise one or more event tree structures that have been previously recognized as malicious. The event tree structures in the malicious event tree structures database 519 may be classified into different sets based on priority levels, and/or network groups (e.g., the group alpha 507 comprising the client devices 501A, 501B, 501C, and the group beta 515 comprising the client devices 509A, 509B). In some embodiments, the malicious event tree structures database 519 may maintain a set of previously recognized malicious event tree structures for individual groups, such as a first set of malicious event tree structures for the group alpha 507 and a second set of malicious event tree structures for the group beta 515. In some examples, an event tree structure that may be deemed malicious for the client devices in one group may not be deemed as malicious for other groups. A priority level of event tree structures in the malicious event tree structures database 519 may indicate the severity of harm that may be caused by the malicious event (e.g., low, moderate, high, severe, and so on). The malicious event tree structures database 519 may also include other optional information that might be helpful for the functionality of the malicious event detection system 517, e.g., a source who classified the event tree structure as malicious, the timestamp of entry of the event tree structure, and/or other information as discussed herein. The previously recognized malicious event tree structures in the malicious event tree structures database 519 may be stored as binary tree data structures where parent nodes have no more than two child nodes, B-Tree data structures where parent nodes can have more than two child nodes, heap data structures which satisfies the criteria that the value of the parent node can be either greater than or equal to the value of child node or less than the value of the child node, N-ary tree data structures where the maximum number of children that a node can have is limited to N, and/or R-tree data structures used for spatial access methods, i.e., for indexing multi-dimensional information such as geographical coordinates, or shapes.

The benign event tree structures database 521 may comprise one or more event tree structures that have been previously recognized as benign or not malicious. The event tree structures in the benign event tree structures database 521 may be classified into different sets based on network groups (e.g., the group alpha 507 comprising the client devices 501A, 501B, 501C, and the group beta 515 comprising the client devices 509A, 509B). In some embodiments, the benign event tree structures database 521 may maintain a set of previously recognized benign event tree structure for individual groups, such as a first set of benign event tree structures for the group alpha 507, and a second set of event tree structures for the group beta 515. In some examples, an event tree structure that may be deemed benign or not malicious for the client devices in one group may be deemed malicious for other groups. The benign event tree structures database 521 may also include other optional information that might be helpful for the functionality of the malicious event detection system 517, e.g., a source who classified the event tree structure as benign, the timestamp of entry of the event tree structure, and/or other information as discussed herein. The previously recognized benign event tree structures in the benign event tree structures database 521 may be stored as binary tree data structures where parent nodes have no more than two child nodes, B-Tree data structures where parent nodes can have more than two child nodes, heap data structures which satisfies the criteria that the value of the parent node should be either greater than or equal to the value of child node or less than the value of the child node, N-ary tree data structures where the maximum number of children that a node can have is limited to N, and/or R-tree data structures.

The malicious event detection system 517 may be variously configured and may include software components such as a malicious event tree structure detector 527, a remedy coordinator 529, and/or an event tree structure generator 533.

The event tree structure generator 533 may analyze the data or event records received from the client devices 501A-501C, 509A-509B, and identify a triggering event that satisfies one or more triggering conditions in the triggering condition database 525. The event tree structure generator 533 may then identify more events related to the triggering event from the data or event records received from the client devices 501A-501C, 509A-509B, and generate an event tree structure. For example, an event record may include data describing an event type of the event (e.g., “database accessed,” “file opened,” “network connection established,” “DNS request made” and so on), information about an application that executed the event, a parent application that initiated the event initiating application, event timestamps, filenames for file accessed during the event, file timestamps, file handles, a program identifier for the application, IP or other network addresses accessed during the event (e.g., of computing devices or peers with which it is communicating or is attempting to communicate), network port numbers (e.g., local or remote), and so on. For identifying events related to the triggering event, the event tree structure generator 533 may analyze the event records to determine the application that executed the triggering event (e.g., by determining the name or identifier of the application). The event tree structure generator 533 may then determine, from the event records, other events executed by the application that executed the triggering event. The event tree structure generator 533 may determine the parent application that initiated the execution of the application that executed the triggering event and other events executed by the parent application.

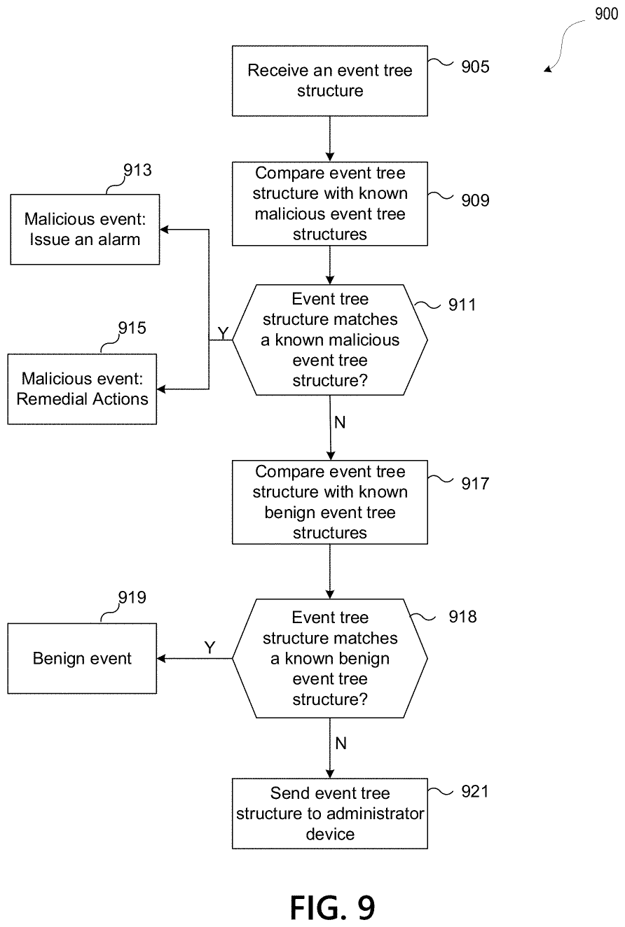

The malicious event tree structure detector 527 may compare the generated event tree structure to one or more previously recognized malicious event tree structures in the malicious event tree structure database 519 and/or one or more previously recognized benign tree structures in the benign event tree structure database 521. Further details about the comparison process of the generated event tree structure and one or more previously recognized benign tree structures are provided at step 909 in FIG. 9. If the malicious event tree structure detector 527 determines that the generated event tree structure matches one of the previously recognized malicious event tree structures in the malicious event tree structure database 519, the malicious event tree structure detector 527 may send a signal or instruction to the remedy coordinator 529. The remedy coordinator 529 may be software and/or hardware components in the malicious event detection system 517 that may cause remedial actions in the client device, where the triggering event was executed, to mitigate the harm caused by the malicious triggering event and other events related to the triggering event. Various remedial actions may be taken by the remedy coordinator 529 to mitigate the harm. The remedial actions may include, but are not limited to, ending execution of the triggering application that executed the triggering event, ending executions of one or more applications associated with the malicious event tree structure, and/or initiating repair of damages caused by the one or more other events in the malicious event tree structure.

If the generated event tree structure does not wholly or partially match any one of the previously recognized malicious event tree structures in the malicious event tree structure database 519 and/or any one of the previously recognized benign tree structures in the benign event tree structure database 521, the malicious event detection system may send the generated event tree structure to the administrator device 537. The administrator device 537 may comprise, for example, a smartphone, a personal computer, a tablet, a desktop computer, a laptop computer, or any other computing device. Additionally or alternatively, the administrator device 537 may comprise, for example, the computers 107, 109, the terminals 240, the client computers 411-414 as discussed above in connection with FIGS. 1-2 and 4, or the computers 103, 105, the servers 206, the virtualization server 301, or the management server 410, as discussed above in connection with FIGS. 1-4. The administrator device 537 may classify the generated event tree structure as benign or malicious and send the classification information to the malicious event detection system 517. The administrator device 537 may classify the generated event tree structure as benign or malicious based on the originating client device or the originating group of client devices of the events in the generated event tree structure. If the administrator device 537 classifies the generated event tree structure as benign, the malicious event detection system 517 may add the generated tree to the benign event tree structures database 521. If the administrator device 537 classifies the generated event tree structure as malicious, the malicious event detection system 517 may add the generated tree to the malicious event tree structures database 519.

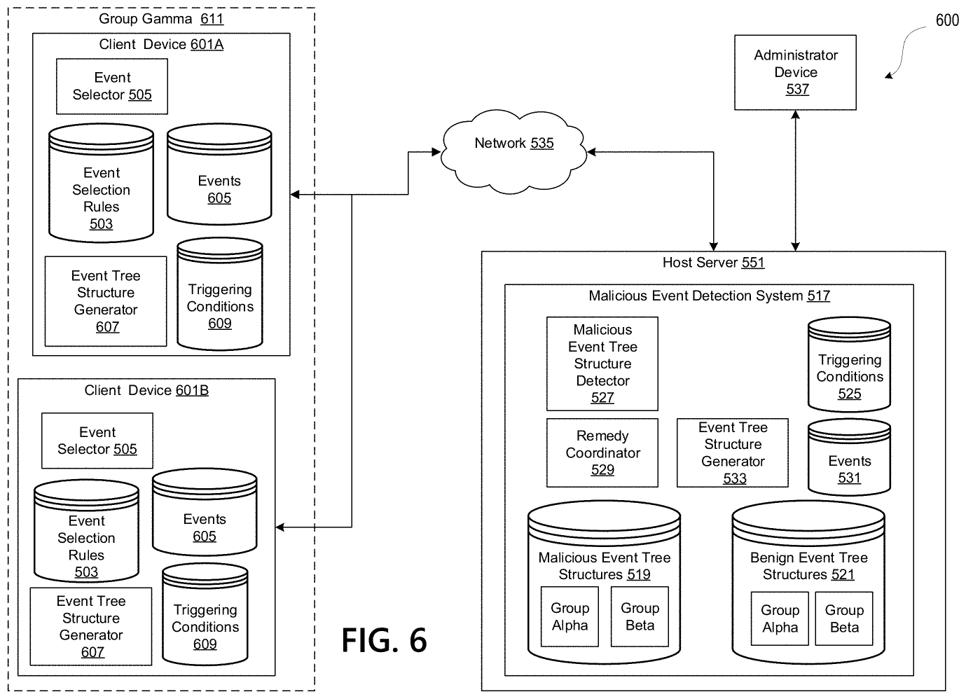

FIG. 6 depicts a schematic diagram showing another example system 600 detecting malicious events in client devices. In addition to network 535, the administrator device 537, and the host server 551 hosting a malicious event detection system 517 in FIG. 5, the system 600 may comprise a group of client devices (e.g., the group gamma 611), including one or more client devices (e.g., the client devices 601A-601B). Instead of sending data or event records of events occurring in a client device of the client devices 601A-601B to the malicious event detection system 517, the client device may detect a triggering event, generate an event tree structure based on the triggering event, and send the generated event tree structure to the malicious event detection system 517. Based on an indication from the malicious event detection system 517 of whether the generated event tree structure is malicious, the client device of the client devices 601A-601B may initiate remedial actions to mitigate damages caused by the malicious triggering event.

In addition to the event selection rules database 503, the client devices 601A-601B in the group gamma 611 may comprise a triggering conditions database 609 and an events database 605. Data or event records of events occurring at the client devices 601A-601B may be stored at the events database 605. The triggering conditions database 609 may comprise rules that define the underlying logic for identifying trigger conditions for malicious events.

In addition to an event selector 505, a client device of the client devices 601A-601B may comprise software components such as an event tree structure generator 607. Similar to the event tree generator 533 in the malicious event detection system 517, the event tree structure generator 607 in a client device may analyze the data or event records stored at the events database 605 and identify a triggering event that satisfies one or more triggering conditions in the triggering condition database 609. The event tree structure generator 607 may then identify more events related to the triggering event from the events database 605 and generate an event tree structure. The event tree structure generator 607 may send the generated event tree structure to the malicious event detection system 517. The malicious event tree structure detector 527 in the malicious event detection system 517 may compare the generated event tree structure to one or more previously recognized malicious event tree structures in the malicious event tree structure database 519 and/or one or more previously recognized benign tree structures in the benign event tree structure database 521. If the malicious event tree structure detector 527 determines that the generated event tree structure matches one of the previously recognized malicious event tree structures in the malicious event tree structure database 519, the remedy coordinator 529 may cause or otherwise initiate remedial actions in the client device where the triggering event was executed to mitigate the harm caused by the malicious triggering event and other events related to the triggering event. Conversely, the remedy coordinator 529 may send a signal to the client device to take remedial actions.

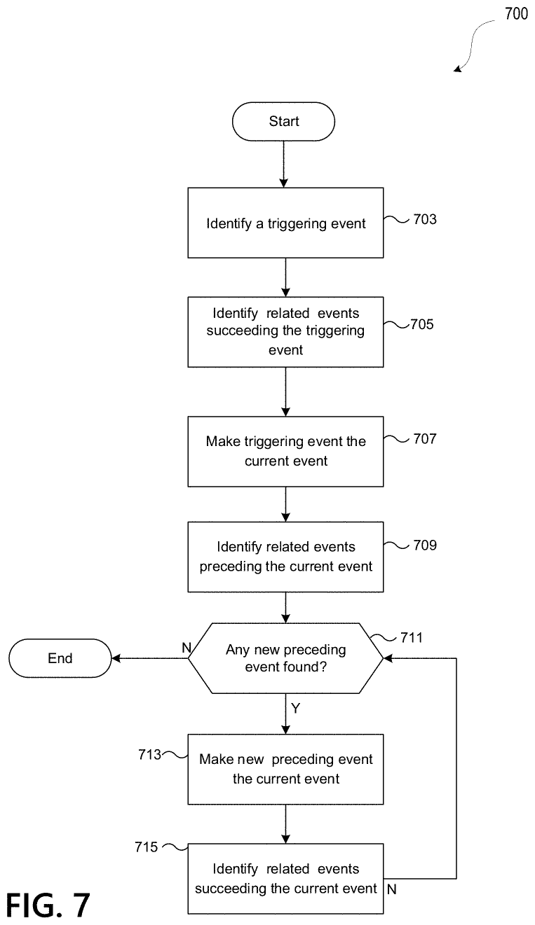

FIG. 7 is a flowchart showing an example process 700 for generating an event tree structure. While the steps of the event sequence in the process 700 are described in a particular order, the order of the steps may be altered without departing from the scope of the disclosure provided herein. The event sequence in the process 700 may be performed by the event tree structure generator 533 in the malicious event detection system 517 and/or the event tree structure generator 607 in the client devices 601A-601B. Although the event sequence is described as being performed by a particular arrangement of computing systems, devices, and/or networks, the processes may be performed by a greater or smaller number of computing systems, devices, and/or networks, and/or by any type of computing system, device, and/or network.

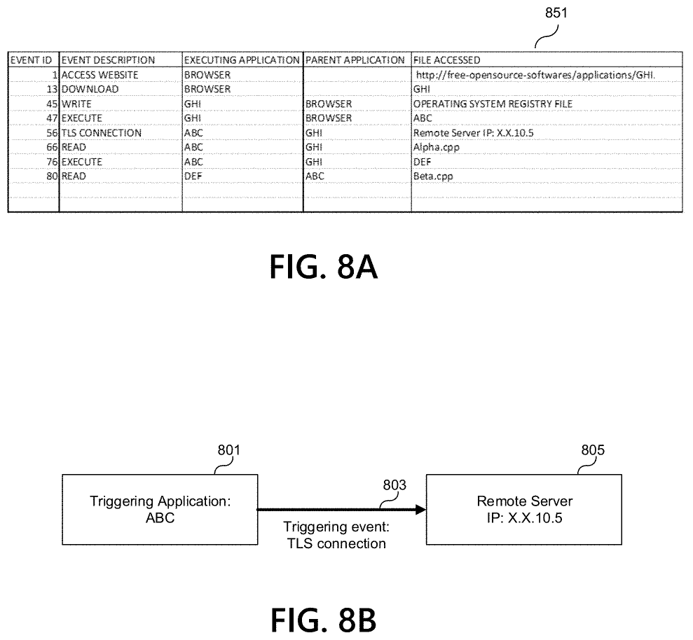

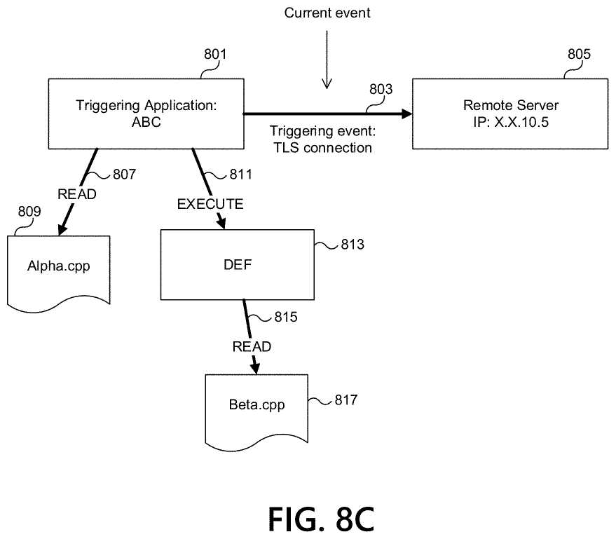

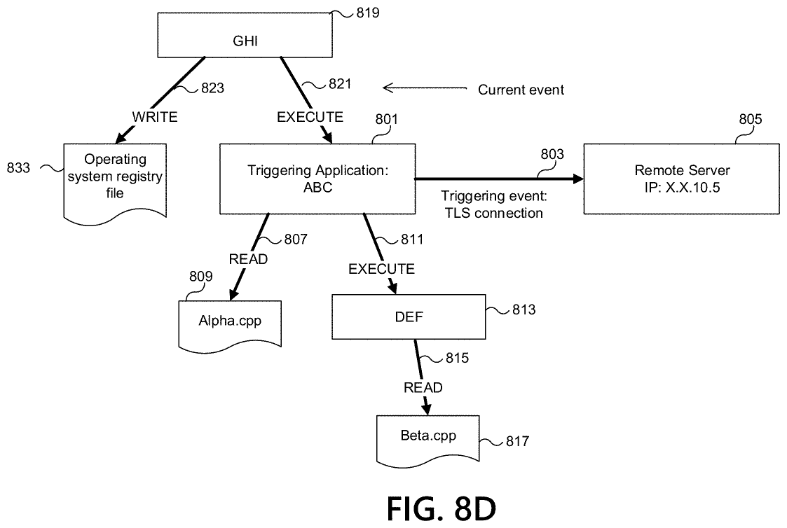

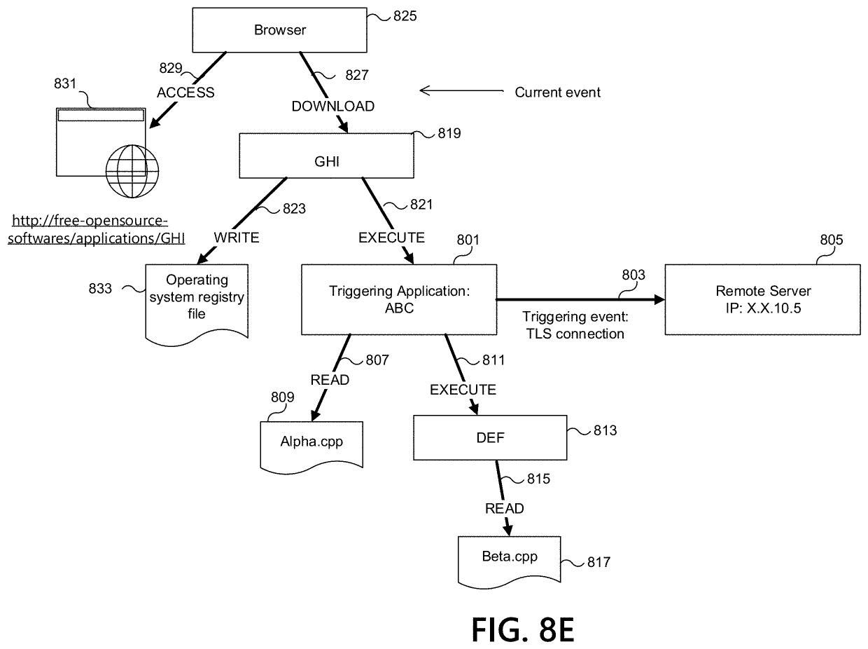

At step 703, an event tree structure generator (e.g., the event tree structure generator 533 in the malicious event detection system 517 and/or the event tree structure generator 607 in the client devices 601A-601B) may identify a triggering event from an event record (e.g., the event records 851 illustrated in FIG. 8A). The malicious event detection system 517 in FIG. 5 may receive the event record from one of the client devices 501A-C, 509A-B, and store the event record in the events database 531. Conversely, the event selector 503 in the client devices 601A-B may generate the event record while monitoring events occurring in the client devices 601A-B and store the event record in the events database 605.

FIG. 8A shows an example event record that comprises a series of events that occurred at a client device, which is used in the example process 700 to generate an event tree structure. The event record 851 in FIG. 8A may comprise multiple entries where at least one entry specifies, for example but not limited to, a description for an event, an identifier for the event, a name for the application that initiated the event, a name for a parent application which started execution of the current application, names of any files accessed. The event record 851 may comprise the following events: (a) a browser application may initiate an event with an event ID 1 where a website with the address “//free-opensource-softwares/applications/GHI” is accessed; (b) the browser application may initiate an event with an event ID 13 where a self-executing file GHI is downloaded; (c) the application GHI downloaded through the browser (i.e., the parent application”) may initiate a write event with an event ID 45 where an operating system registry file is modified; (d) the application GHI may initiate an execution event of another application ABC with an event ID 47; (e) the application ABC with the parent application GHI may initiate an event with an event ID 56 where a connection is created with the remote server with IP address X.X.10.5; (f) the application ABC may also initiate an event with an event ID 66 that reads a file named alpha.cpp; (g) the application ABC may also initiate an event with an event ID 76 that where another application DEF is executed; and (h) the application DEF with the parent application ABC may initiate a read event with an event ID 80 where a file named beta.cpp is accessed.

The event tree structure generator 533 in the malicious event detection system 517 may identify one or more triggering events from the stored event record 851 that satisfy one or more triggering rules. The event tree structure generator may determine that an event is a triggering event (hereinafter referred to as triggering event 803), where a triggering application ABC 801 creates a connection to a remote server 805 with Internet Protocol (IP) address X.X.10.5 using a transport layer security (TLS) protocol. The event tree structure generator may start generating the event tree structure (e.g., the event tree structure in FIG. 8B) by adding the triggering application ABC 801, and the remote server 805 as nodes of the event tree structure of the triggering event 803, and the triggering event 803 as the connection between the nodes.

Referring back to FIG. 7, at step 705, the event tree structure generator 533 or 607 may identify one or more succeeding events that follow the triggering event in the event records stored in the events database. The event records may comprise timestamps of the events occurring in the client devices and/or records of application in the client device that are executing the events. The event tree structure generator 533 may identify the succeeding events based on the timestamps and executing application information in the event records. Various other methodologies may be employed by the event tree structure generator to identify the succeeding events. In some examples, the event tree structure generator may determine the triggering application that initializes executions of other applications that execute the succeeding events. The event tree structure generator may determine the triggering application by analyzing the event record associated with the triggering event to identify the application that executed the triggering event. Alternatively, or additionally, the event tree structure generator may determine the succeeding events executed by the triggering application. The event tree structure generator may continue identifying succeeding events until all the succeeding events of the triggering event are accounted for.

For example, the event tree structure generator 533 or 607 may identify the succeeding events of the triggering event 803 by identifying, from the event record 851, other events executed by the triggering application (e.g., the read event with event ID 66 and the execute event of the application GHI with event ID 76), and events (e.g., the read event with event ID 80) executed by the application (e.g., application GHI) executed by the triggering application (e.g., application ABC). FIG. 8C illustrates the succeeding events 807, 811 of the triggering event 803. The event tree structure generator may determine from the event record 851 that the triggering application ABC 801 has executed a succeeding event 807 that read a file, alpha.cpp 809. Concurrently or subsequently, the event tree structure generator may determine that the triggering application ABC 801 has executed a succeeding event 811 that executed another application DEF 813. The event tree structure generator may determine that the application DEF 813 may execute another succeeding event 815 where the application DEF 813 reads a file, beta.cpp 817. The event tree structure generator may add the file alpha.cpp 809, the file beta.cpp 817, and the application DEF 813 as nodes below the triggering application ABC 801 node in the event tree structure and the read events 807, 815, and the execute event 811 as the connections between the newly determined nodes.

Referring back to FIG. 7, at step 707, the event tree structure generator may identify or mark the triggering event as the current event. For example, the event tree structure generator may identify the triggering event 803 in FIG. 8B as the current event. At step 709, the event tree structure generator may determine if there is any preceding event that precedes the current event in the event records stored in the events database. If the event tree structure generator identifies a preceding event at step 711, the process advances to step 713, where the event tree structure generator may identify the preceding event as the current event. For example, the event tree structure generator may identify, from the event record 851, that an execute event with event ID 47 is the preceding event of the triggering event marked as the current event as the execute event initiated the execution of the triggering application.

At step 715, the event tree structure generator may identify succeeding events for the current event based on the timestamps and executing application information in the event records. In some examples, the event tree structure generator may identify an application that initiated the current event. For example, the event tree structure generator may identify, from the event record 851, that the preceding event was executed by the application GHI. Alternatively or additionally, the event tree structure generator may identify events initiated by the application that executed the current event and then identify events executed by the application before the current event.

As illustrated in FIG. 8D, the event tree structure generator may identify from the event record 815 the execute event 821 as the preceding event of the triggering event 803 identified as the current event. The event tree structure generator may mark the execute event 821 as the current event. The event tree structure generator may then identify, from the event record 851, the application GHI 819 as the application that initiated the triggering application through the execute event 821. Concurrently or subsequently, the event tree structure generator may identify, from the event record 851, other events executed by the application GHI 819. For example, the event tree structure generator may determine the application GHI 819 had executed a write event 823 that modified an operating system registry file 833. The event tree structure generator may add the operating system registry file 833 and the application GHI 819 as nodes above the triggering application ABC 801 node in the event tree structure, and the execute event 821, and the write event 823 as the connections.

Referring back to FIG. 7 and back at step 711, the event tree structure generator determines if there is any other event preceding the current event and, if yes, proceeds to find all preceding events and applications that have executed the preceding events. The event tree structure may be deemed as complete when all the preceding events are accounted for.

For example, as illustrated in FIG. 8E, the event tree structure generator may identify the download event 827 as the preceding event of the execute event 821 marked as the current event. The event tree structure generator may identify the download event 827 as the current event. The event tree structure generator may then identify, from the event record 851, the browser 825 as the application that initiated the download event 827 to download the application GHI 819. Concurrently or subsequently, the event tree structure generator may identify, from the event record 851, other events executed by the browser 825. For example, the event tree structure generator may determine the browser 825 had executed an access event 829, where a website 831 was accessed to download the application GHI 819. The event tree structure generator may add the website 831 and the browser 825 as nodes in the event tree structure, and the download event 827 and the access event 829 as the connections between the newly added nodes.

After the event tree structure generator 533 in the malicious event detection system 517 in FIG. 5 generates an event tree structure, the event tree structure generator 533 may send the generated event tree structure to the malicious event tree structure detector 527. If the event tree structure is generated by the event tree structure generator 607 in a client device in FIG. 6, the event tree structure generator 607 may send the generated event tree structure to the malicious event tree structure detector 527.

FIG. 9 is a flowchart showing an example process 900 for detecting a malicious event. While the steps of the event sequence in the process 900 are described in a particular order, the order of the steps may be altered without departing from the scope of the disclosure provided herein. The event sequence in the process 900 may be performed by the malicious event tree structure detector 527 in the malicious event detection system 517 in FIGS. 5 and 6. Although the event sequence is described as being performed by a particular arrangement of computing systems, devices, and/or networks, the processes may be performed by a greater or smaller number of computing systems, devices, and/or networks, and/or by any type of computing system, device, and/or network.

At step 905, the malicious event tree structure detector 527 may receive an event tree structure from the event tree structure generator 533 in the malicious event detection system 517 in FIG. 5. Alternatively, the malicious event tree structure detector 527 may receive a partial or a whole event tree structure from the event tree structure generator 607 in any one of the client devices 601A-601B in FIG. 6.

At step 909, the malicious event tree structure detector may compare the received event tree structure to known malicious event tree structures in the malicious event tree structures database 519. Two event tree structures may be equivalent if they both have the same topology and if the corresponding nodes and connections between the nodes are equivalent. Various methodologies may be used by the malicious event tree structure detector to compare the received event tree structure and a known malicious event tree structure in the malicious event tree structures database 519. For example, two event tree structures may be compared by determining a “difference” distance between components of the two event tree structures. The components may be the nodes and/or the connection between the nodes. In some embodiments, the difference distance between two event tree structures may have to be below a threshold (e.g., a predetermined threshold) in order to determine that the two event tree structures are similar. In some embodiments, the distance between two event tree structures may have to be zero in order to determine that the two event tree structures are similar. In some embodiments, the malicious event tree structure detector may compare the received event tree structure to a portion of a known malicious event tree structure in the malicious event tree structures database 519. For example, the portion may be considered as an event tree structure on its own when it is compared to the received event tree structure.

In some examples, the received event tree structure is of a particular group, the malicious event tree structure detector may compare the received event tree structure to known malicious event tree structures for that particular group in the malicious event tree structures database 519. For example, if the received event tree structure is from any one of the client devices 501A-501C in the group alpha 507, the malicious event tree structure detector may compare the received event tree structure to known malicious event tree structures for that group alpha 507 in the malicious event tree structures database 519. The malicious event tree structure detector may additionally compare the received event tree structure to known malicious event tree structures for other groups in the malicious event tree structures database 519.

At step 911, if the received event tree structure matches at least a portion of a known malicious event tree structures in the malicious event tree structures database 519, the malicious event tree structure detector may determine that the received event tree structure is indicative of malicious activities. The malicious event tree structure detector may further determine that the triggering event that initiated the generation of the received event tree structure is a malicious event. The malicious event tree structure detector may then send instructions or a signal to initiate remedial actions to mitigate and perhaps eliminate malicious activity at the compromised client device at step 915. Alternatively or additionally, at step 913, the malicious event tree structure detector may issue an alarm or other notification to the compromised client device and/or the administrator device about the malicious activities in the compromised client device. The remedial actions may include, but not limited to, ending execution of the triggering application that executed the triggering event, ending executions of one or more applications associated with the malicious event tree structure, and/or initiating repair of damages caused by the one or more other events in the malicious event tree structure. For example, if the event tree structure is FIG. 8D is determined to be malicious, remedial actions may be taken to end the TLS connection, stop the execution of the application ABC 801, stop the execution of the application DEF 813, stop the execution of the application GHI 819, remove one or more of the applications ABC 801, DEF 813, and GHI 819 from the compromised client device, and/or restore the operating system registry file to a state before the write event 823. In some examples, remedial actions may also include classifying one or more events in the malicious event tree structure as triggering conditions for malicious activities and/or adding the classified events to the triggering conditions database 525 in the malicious event detection system 517 or the triggering conditions database in the client devices 601A-601B. For example, the downloading event 827 from the website 831 can be added as a new triggering condition to the triggering conditions database 525 in FIG. 5 or the triggering conditions databases 609 in FIG. 6.

Referring back to FIG. 9, at step 917, if the received event tree structure does not match any known malicious event tree structures in the malicious event tree structures database 519, the malicious event tree structure detector may compare the received event tree structure to known benign event tree structures in the benign event tree structures database 521. One or more methodologies used to compare the received event tree structure to known benign event tree structures. In some examples, if the received event tree structure is of a particular group, the malicious event tree structure detector may compare the received event tree structure to known benign event tree structures for that particular group in the benign event tree structures database 521. For example, if the received event tree structure is from any one of the client devices 501A-C in the group alpha 507, the malicious event tree structure detector may compare the received event tree structure to known benign event tree structures for that group alpha in the benign event tree structures database 521. The malicious event tree structure detector may additionally compare the received event tree structure to known benign event tree structures for other groups in the benign event tree structures database 521.

At step 918, if the received event tree structure matches at least a portion of a known benign event tree structure in the benign event tree structures database 521, the malicious event tree structure detector may determine that the received event tree structure is benign or not malicious at step 919. The malicious event tree structure detector may further determine that the triggering event that initiated the generation of the received event tree structure is a benign event. Additionally, the malicious event tree structure detector may send a signal to the client device where the events in the received event tree structure occurred that the triggering event is benign and/or not malicious.

At step 921, if the received event tree structure does not match any known benign event tree structures in the benign event tree structures database 521, the malicious event tree structure detector may send a request to classify the received event tree structure as either malicious or benign. For example, the malicious event tree structure detector may send the received event structure to the administrator device 537 in FIGS. 5 and 6.

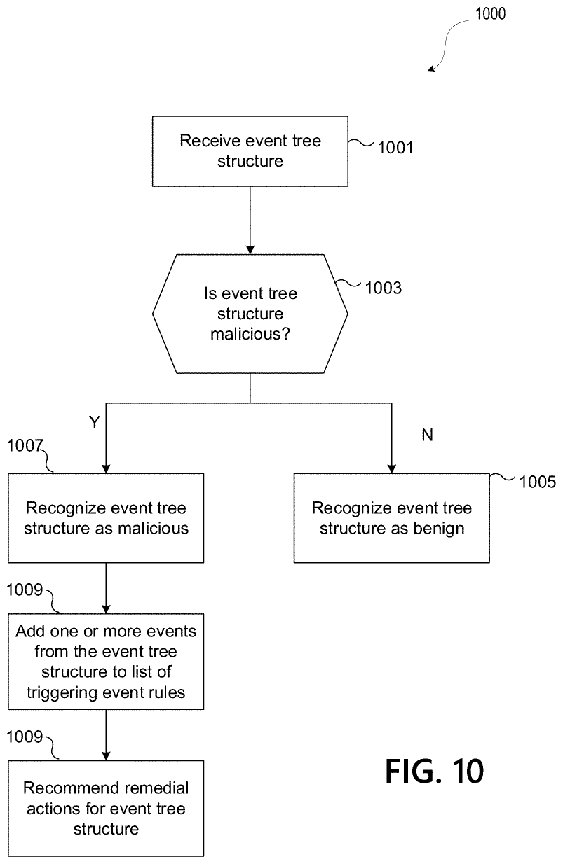

FIG. 10 is a flowchart showing an example method 1000 for classifying an event tree structure as benign or malicious. While the steps of the event sequence in the method 1000 are described in a particular order, the order of the steps may be altered without departing from the scope of the disclosure provided herein. The event sequence in the method 1000 may be performed by the administrator device 537 in FIGS. 5 and 6. Although the event sequence is described as being performed by a particular arrangement of computing systems, devices, and/or networks, the processes may be performed by a greater or smaller number of computing systems, devices, and/or networks, and/or by any type of computing system, device, and/or network.

At step 1001, the administrator device 537 may receive the event tree structure (or a portion thereof) from the malicious event tree structure detector 527 in FIG. 5 or 6. The malicious event detection system may send the event tree structure to the administrator device 537 if the event tree structure does not match any one of the previously recognized malicious event tree structures in the malicious event tree structure database 519 and/or any one of the previously recognized benign tree structures in the benign event tree structure database 521.

At step 1003, the administrator device 537 may classify the received event tree structure as benign or malicious. Additionally, the administrator device 537 may send the classification information of the event tree structure to the malicious event detection system 517. In some examples, the administrator device 537 may classify the event tree structure as benign or malicious based on the originating client device or the originating group of client devices of the events in the event tree structure. For example, creating a TLS connection may be a malicious event for the client devices 501A-501C in the group alpha 507 but a benign event for the client devices 509A-509B in the group beta 515.

At step 1005, if the administrator device 537 classifies the event tree structure as benign, the administrator device 537 may send a signal to the malicious event detection system 517 that the event tree structure is benign. Additionally, the malicious event detection system 517 or the administrator device 537 may add the event tree structure to the benign event tree structures database 521.

At step 1007, if the administrator device 537 classifies the received event tree structure as malicious, the administrator device 537 may send a signal to the malicious event detection system 517 that the event tree structure is malicious. Additionally, the malicious event detection system 517 or the administrator device 537 may add the event tree structure to the malicious event tree structures database 519.

Furthermore, at step 1009, the administrator device 537 may send a signal to the malicious event detection system 517 to classify one or more events in the malicious event tree structure as triggering conditions for malicious activities and add the classified events to the triggering conditions database 525 in the malicious event detection system 517 or the triggering conditions database in the client devices 601A-601B. For example, the administrator device 537 may add the access event 829 to the website 831 as a triggering condition as the website may potentially store various malware. Additionally, at step 1009, the administrator device 537 may recommend remedial actions to mitigate damages caused by the events in the received event tree structure.

The following paragraphs (M1) through (M7) describe examples of methods that may be implemented in accordance with the present disclosure.

(M1) A method comprising: receiving, by a computing device, data from a client device, the data indicative of an occurrence of a first event of a first application on the client device; identifying, by the computing device, a relationship between the first event and a second event of the first application based on a series of events that includes the first event and the second event of the first application; determining, by the computing device that the first event is potentially malicious activity based on a comparison between the identified relationship and other series of events previously determined to be malicious activity; and initiating, by the computing device, an action to modify a configuration of the client device responsive to the determination that the first event is potentially malicious activity.

(M2) A method may be performed as described in paragraph (M1), further comprising selecting, by the computing device and from the client device, the series of events based on a determination that each one of the series of events satisfies one or more event selection rules.

(M3) A method may be performed as described in any of the paragraphs (M1) through (M2) further comprising receiving, by the computing device and from a client agent enabling a virtual environment on the client device, the data.

(M4) A method may be performed as described in any of paragraphs (M1) through (M3) wherein the identifying the relationship further comprises determining, from the series of events, one or more of the following: one or more second applications that enabled an execution of the first application; one or more third applications executed by the first application; and one or more third events indicating relationships among the first application, the one or more second applications, and the one or more third applications.

(M5) A method may be performed as described in any of paragraphs (M1) through (M4) wherein the initiating the action to modify the configuration of the client device comprises: causing, by the computing device, an ending of the execution of the first application on the client device; causing, by the computing device, endings of executions of at least one of the one or more second applications or the one or more third applications; initiating, by the computing device, repair of damages caused by the one or more third events; or causing, by the computing device, an output of a notification indicating that the first event is malicious.

(M6) A method may be performed as described in any of paragraphs (M1) through (M5) wherein the first event satisfies one or more triggering rules from a list of triggering rules; and wherein the initiating the action to modify the configuration of the client device comprises: determining, by the computing device and from the series of events, an event associated with a download of the first application on the client device; and adding, by the computing device, the event associated with the download to the list of triggering rules.

(M7) A method may be performed as described in any of paragraphs (M1) through (M6) further comprising determining, by the computing device, that the identified relationship does not match a portion of any one of the other series of events previously determined to be malicious activity; causing, by the computing device, an output indicating a presence of the identified relationship; and receiving, by the computing device, an indication that the identified relationship is determined as malicious activity.

The following paragraphs (M8) through (M10) describe examples of methods that may be implemented in accordance with the present disclosure.

(M8) A method comprising: receiving, by a computing device, data from a client device, the data indicative of occurrences of a series of events on the client device; identifying, by the computing device and from the series of events, a first event satisfying one or more triggering rules; identifying, by the computing device, a relationship between the first event and one or more other events from a series of events that includes the first event and the one or more other events; determining, by the computing device, that the first event is potentially malicious activity based on a comparison between the identified relationship and other series of events previously determined to be malicious activity; and initiating, by the computing device, an action to modify a configuration of the client device responsive to the determination that the first event is potentially malicious activity.

(M9) A method may be performed as described in paragraph (M8), wherein the receiving the data comprises: receiving, by the computing device and from a client agent enabling a virtual environment on the client device, the data.

(M10) A method may be performed as described in any of paragraphs (M8) through (M10), wherein the identifying the relationship further comprises determining, from the series of events, one or more of the following: a first application that enabled the occurrence of the first event; one or more second applications that enabled an execution of the first application; and one or more third applications executed by the first application; and wherein an occurrence of each one of the one or more other events were enabled by the first application, the one or more second applications, or the one or more third applications.

The following paragraphs (A1) through (A7) describe examples of apparatuses that may be implemented in accordance with the present disclosure.

(A1) An apparatus comprising one or more processors, and memory storing instructions that, when executed by the one or more processors, cause the apparatus to: receive data from a client device, the data indicative of an occurrence of a first event of a first application on the client device; identify a relationship between the first event and a second event of the first application based on a series of events that includes the first event and the second event of the first application; determine that the first event is potentially malicious activity based on a comparison between the identified relationship and other series of events previously determined to be malicious activity; and initiate an action to modify a configuration of the client device responsive to the determination that the first event is potentially malicious activity.

(A2) An apparatus as described in the paragraph (A1), wherein the instructions, when executed by the one or more processors, are configured to receive the data by: selecting the series of events based on a determination that each one of the series of events satisfies one or more event selection rules.

(A3) An apparatus as described in any one of the paragraphs (A1) through (A2), wherein the instructions, when executed by the one or more processors, are configured to identify the relationship from the series of events by further determining one or more of the following: one or more second applications that enabled an execution of the first application; one or more third applications executed by the first application; and one or more third events indicating relationships among the first application, the one or more second applications, and the one or more third applications.

(A4) An apparatus as described in any one of the paragraphs (A1) through (A3), wherein the instructions, when executed by the one or more processors, are configured to initiate the action to modify the configuration of the client device by: causing an ending of the execution of the first application on the client device.

(A5) An apparatus as described in any one of the paragraphs (A1) through (A4), wherein the instructions, when executed by the one or more processors, are configured to initiate the action to modify the configuration of the client device by: causing an ending of the execution of at least one of the one or more second applications or the one or more third applications.

(A6) An apparatus as described in any one of the paragraphs (A1) through (A5), wherein the first event satisfies one or more triggering rules from a list of triggering rules; and wherein the instructions, when executed by the one or more processors, are configured to initiate the action to modify the configuration of the client device by: determining, from the series of events, an event associated with a download of the first application on the client device; and adding the event associated with the download to the list of triggering rules.

(A7) An apparatus as described in any one of the paragraphs (A1) through (A6), wherein the instructions, when executed by the one or more processors, are configured to initiate the action to modify the configuration of the client device by: initiating repair of damages caused by the one or more third events.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

1. A method comprising:
receiving, by a computing device, data from a client device, data indicative of occurrences of a series of events that includes a first event of a first application on the client device and a second event;
identifying, by the computing device and based the series of events, a relationship between the first event and the second event;
determining, by the computing device, that the first event is potentially malicious activity based on a comparison between the identified relationship and other series of events previously determined to be malicious activity; and
initiating, by the computing device, an action to modify a configuration of the client device responsive to the determination that the first event is potentially malicious activity.

2. The method of claim 1, wherein the receiving the data comprises:
selecting, by the computing device and from the client device, the series of events based on a determination that each one of the series of events satisfies one or more event selection rules.

3. The method of claim 1, wherein the receiving the data comprises:
receiving, by the computing device and from a client agent enabling a virtual environment on the client device, the data.

4. The method of claim 1, wherein the identifying the relationship further comprises determining, from the series of events, one or more of the following:
one or more second applications that enabled an execution of the first application;
one or more third applications executed by the first application; and
one or more third events indicating relationships among the first application, the one or more second applications, and the one or more third applications.

5. The method of claim 4, wherein the initiating the action to modify the configuration of the client device comprises:
causing, by the computing device, an ending of the execution of the first application on the client device;
causing, by the computing device, endings of executions of at least one of the one or more second applications or the one or more third applications; or
initiating, by the computing device, repair of damages caused by the one or more third events.

6. (canceled)

7. The method of claim 4, wherein the first event satisfies one or more triggering rules from a list of triggering rules; and
wherein the initiating the action to modify the configuration of the client device comprises:
determining, by the computing device and from the series of events, an event associated with a download of the first application on the client device; and
adding, by the computing device, the event associated with the download to the list of triggering rules.

8. (canceled)

9. The method of claim 1, further comprising:
causing, by the computing device, an output of a notification indicating that the first event is malicious.

10. The method of claim 1, further comprising:
determining, by the computing device, that the identified relationship does not match a portion of any one of the other series of events previously determined to be malicious activity;
causing, by the computing device, an output indicating a presence of the identified relationship; and
receiving, by the computing device, an indication that the identified relationship is determined as malicious activity.

11. An apparatus comprising:
one or more processors; and
memory storing instructions that, when executed by the one or more processors, cause the apparatus to:
receive data from a client device, data indicative of occurrences of a series of events that includes a first event of a first application on the client device and a second event;
identify, based on the series of events, a relationship between the first event and the second event;
determine that the first event is potentially malicious activity based on a comparison between the identified relationship and other series of events previously determined to be malicious activity; and
initiate an action to modify a configuration of the client device responsive to the determination that the first event is potentially malicious activity.

12. The apparatus of claim 11, wherein the instructions, when executed by the one or more processors, are configured to receive the data by:
selecting the series of events based on a determination that each one of the series of events satisfies one or more event selection rules.

13. The apparatus of claim 11, wherein the instructions, when executed by the one or more processors, are configured to identify the relationship from the series of events by further determining one or more of the following:
one or more second applications that enabled an execution of the first application;
one or more third applications executed by the first application; and
one or more third events indicating relationships among the first application, the one or more second applications, and the one or more third applications.

14. The apparatus of claim 13, wherein the instructions, when executed by the one or more processors, are configured to initiate the action to modify the configuration of the client device by:
causing an ending of the execution of the first application on the client device;
causing an ending of the execution of at least one of the one or more second applications or the one or more third applications; or
initiating repair of damages caused by the one or more third events.

15. (canceled)

16. The apparatus of claim 13, wherein the first event satisfies one or more triggering rules from a list of triggering rules; and
wherein the instructions, when executed by the one or more processors, are configured to initiate the action to modify the configuration of the client device by:
determining, from the series of events, an event associated with a download of the first application on the client device; and
adding the event associated with the download to the list of triggering rules.

17. (canceled)

18. A method comprising:
receiving, by a computing device, data from a client device, data indicative of occurrences of a series of events on the client device;
identifying, by the computing device and from the series of events, a first event satisfying one or more triggering rules;
identifying, by the computing device, a relationship between the first event and one or more other events from the series of events;
determining, by the computing device, that the first event is potentially malicious activity based on a comparison between the identified relationship and other series of events previously determined to be malicious activity; and
initiating, by the computing device, an action to modify a configuration of the client device responsive to the determination that the first event is potentially malicious activity.

19. The method of claim 18, wherein the receiving the data comprises:
receiving, by the computing device and from a client agent enabling a virtual environment on the client device, the data.

20. The method of claim 18, wherein the identifying the relationship further comprises determining, from the series of events, one or more of the following:
a first application that enabled an occurrence of the first event;
one or more second applications that enabled an execution of the first application; and
one or more third applications executed by the first application, and
wherein an occurrence of each one of the one or more other events was enabled by the first application, the one or more second applications, or the one or more third applications.

21. The method of claim 20, wherein the initiating the action to modify the configuration of the client device comprises:
causing, by the computing device, an ending of the execution of the first application on the client device;
causing, by the computing device, endings of executions of at least one of the one or more second applications or the one or more third applications; or
initiating, by the computing device, repair of damages caused by the one or more other events.

22. The method of claim 1, wherein the first event of the first application is generated by the first application; or
wherein the second event is generated by the first application or another application different than the first application.

23. The apparatus of claim 11, wherein the first event of the first application is generated by the first application; or
wherein the second event is generated by the first application or another application different than the first application.

24. The method of claim 20, wherein the first event is generated by the first application; or
wherein the one or more other events are generated by the first application or another application different than the first application.
